(19) United States
(12) Patent Application Publication
(10) Pub. No.: US 2007/0002525 A1
(43) Pub. Date: Jan. 4, 2007

(54) Sheet for capacitor electrodes, method and apparatus for manufacturing the same, and electrolytic capacitors

(75) Inventors: Tomoaki Yamanoi, Oyama-shi (JP); Hiroyuki Kawabata, Oyama-shi (JP); Atsushi Otaki, Oyama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Showa Denko K.K., Tokyo (JP)

(21) Appl. No.: 10/569,804

(22) PCT Filed: Aug. 27, 2004
(86) PCT No.: PCT/JP04/12809

§ 371 Date: Feb. 27, 2006

Related U.S. Application Data
(60) Provisional application No. 60/499,364, filed on Sep. 3, 2003.

(30) Foreign Application Priority Data
Aug. 27, 2003 (JP) 2003-302965

(51) Int. Cl. H01G 9/04; H01G 9/145

(52) U.S. Cl. 361/508

(57) ABSTRACT

A sheet for capacitor electrodes includes an aluminum core sheet 3 and a porous layer 4 formed on at least one surface of the core sheet 3. The porous layer 4 includes an intermetallic compound made of one or more valve metals selected from the group consisting of Ti, Zr, Nb, Hf and Ta, and Al. The porous layer is constituted such that particles of the intermetallic compound are fixed in solid solution in which the one or more valve metals are dissolved in Al. Atomized molten alloy including valve metal and Al is sprayed approximately downward, and an inert gas flow 19 is injected against the spray flow to generate a branched spray flow 16 of the atomized alloy from the spray flow 15. The branched spray flow 16 is jetted against a foil-like core material 3 and then rolled. According to the sheet for capacitor electrodes, larger capacitance can be obtained and the sheet is excellent in bent-resistant performance.

### CROSS REFERENCE TO RELATED APPLICATIONS

This application is an application filed under 35 U.S.C. § 111(a) claiming the benefit pursuant to 35 U.S.C. § 119(e) (1) of the filing date of Provisional Application No. 60/499,364 filed on Sep. 3, 2003 pursuant to 35 U.S.C. §111(b).

Priority is claimed to Japanese Patent Application No. 2003-302965 filed on Aug. 27, 2003, and U.S. Provisional Application No. 60/499,364 filed on Sep. 3, 2003, the disclosure of which are incorporated by reference in their entireties.

### TECHNICAL FIELD

The present invention relates to a sheet for capacitor electrodes capable of obtaining large capacitance and excellent in bent-resistant performance, a method and an apparatus for manufacturing the sheet, and an electrolytic capacitor.

In this disclosure, the language “aluminum” denotes aluminum and its alloy. Furthermore, in this disclosure, the symbol “Al” denotes aluminum (single metal).

### BACKGROUND ART

With digitalization of electric appliances, capacitors small in size, large in capacity and low in impedance at high-frequency range has been requested. Among other things, in personal computers or communication apparatuses such as cellular phones, with the increased operation speed of CPUs to be mounted therein, it has been strongly requested to further increase capacitance of such capacitors.

Conventionally, in computers or communication apparatuses such as cellular phones, in order to cope with miniaturization requests, plastic capacitors, mica capacitors, multilayer ceramic capacitors, etc, have been widely used. However, these capacitors can never attend to the demands of attaining high-capacitance. That is, attaining high-capacitance in these capacitors causes an extremely increased volume, resulting in a failure of meeting the demands of miniaturization and high-capacitance of capacitors.

In view of the above, in recent years, as a capacitor low in impedance, low in equivalent series resistance (ESR value) and large in capacitance and capable of being miniaturized sufficiently, aluminum solid electrolytic capacitor shave been developing. For example, solid electrolytic capacitors in which a dielectric oxide layer is formed on the valve metallic surface of aluminum or the like and a conductive polymer layer (solid electrolyte) is formed on the oxide layer are publicly known by Japanese Unexamined Laid-open Patent Publications H3-276619, H3-276620, H8-130163 and H9-266141.

In general, such solid electrolytic capacitor employs a structure in which a terminal is connected to a part of the valve metallic surface by caulking or ultrasonic welding to form an anode lead terminal, then conductive polymer (solid electrolyte) is laminated on the remaining portion of the valve metallic surface, a cathode layer made of, for example, carbon paste or silver paste is formed thereon, the anode lead terminal is connected to an anode lead frame, the cathode layer is connected to a cathode lead frame, and these members are molded by outer package resin.

As a method for manufacturing an electrolytic capacitor electrode foil, the following methods are publicly known. For example, Japanese Unexamined Laid-open Publication H6-267803 discloses a method in which intermetallic compound powder (e.g., Al₃Zr) having a dendritic structure is formed into a porous manner and sintered. Japanese Unexamined Laid-open Publications H3-196510 and H3-202462 disclose a method of forming a porous layer by evaporating aluminum or its alloy onto at least one surface of an aluminum foil.

However, in the steps of welding a terminal to a part of the valve metallic (anode foil) surface by caulking or ultrasonic welding to form an anode lead terminal and further this anode lead terminal is connected to an anode lead frame, there are problems that the valve metallic anode foil lacks ductility and bent-resistant (bent-resistant performance) and therefore a bad connection tends to occur. Thus, there is a pressing need to improve the bent-resistant performance of an anode foil while fulfilling the demands of miniaturization and high-capacitance.

On the other hand, in roll type aluminum electrolytic capacitors, it has become essential to develop a capacitor small in size, high in capacitance, low in impedance, low in ESR value and further excellent in bent-resistant performance.

Under the circumstances, the electrode foil manufactured by Japanese Unexamined Laid-open Publication H6-267803 is poor in ductility and extremely poor in bent-resistant performance. Furthermore, in the electrode foil manufactured according to the method, only a very thin porous film can be formed, causing insufficient capacitance and insufficient bent-resistant performance. In addition, the manufacturing efficiency is poor because the foil is manufactured with an evaporation apparatus. As will be understood from the above, in conventional manufacturing technique, it was difficult to secure sufficient bent-resistant performance while obtaining large capacitance.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### DISCLOSURE OF INVENTION

The preferred embodiments of the present invention have been developed in view of the above-mentioned and/or other problems in the related art. The preferred embodiments of the present invention can significantly improve upon existing methods and/or apparatuses.

The present invention has been made in view of the aforementioned technical back grounds and aims to provide a sheet for capacitor electrodes capable of attaining miniaturization and obtaining large capacitance and excellent bent-resistant performance, a method for manufacturing the sheet and an electrolytic capacitor small in size and large in capacitance, and an apparatus for manufacturing a sheet for such capacitor electrodes having such performance.

In order to attain the above objects, the present invention provides the following means.

[1] A sheet for capacitor electrodes, comprising:

a porous layer including an intermetallic compound made of one or more valve metals selected from the group consisting of Ti, Zr, Nb, Hf and Ta, and Al,

wherein the porous layer is constituted such that particles of the intermetallic compound are fixed in solid solution in which the one or more valve metals are dissolved in Al, and

wherein porosity of the porous layer is 10% or above.

[2] A sheet for capacitor electrodes, comprising:

a sheet in which a porous layer including an intermetallic compound made of one or more valve metals selected from the group consisting of Ti, Zr, Nb, Hf and Ta, and Al is integrally laminated on at least one surface of a core material including one metal selected from the group consisting of Al, Ti, Zr, Nb, Hf and Ta as a main ingredient,

wherein the porous layer is constituted such that particles of the intermetallic compound are fixed in solid solution in which the one or more valve metals are dissolved in Al, and

wherein porosity of the porous layer is 10% or above.

[3] The sheet for capacitor electrodes as recited in the aforementioned Item 2, wherein a thickness of the core material is 5 to 80 μm and a thickness of the porous layer is 5 to 300 μm.

[4] The sheet for capacitor electrodes as recited in any of the aforementioned Items [1] to [3], wherein the porosity of the porous layer is 10 to 75%.

[5] A method of manufacturing a sheet for capacitor electrodes, the method comprising the steps of:

atomizing molten alloy including one or more valve metals selected from the group consisting of Ti, Zr, Nb, Hf and Ta, and Al into atomized molten alloy;

continuously applying the atomized alloy on a peripheral surface of a rotating single-roll; and

quickly solidifying the applied alloy to obtain a porous sheet.

[6] The method of manufacturing a sheet for capacitor electrodes as recited in the aforementioned Item [5], wherein an average particle diameter of the atomized alloy to be fixed to the single-roll is 0.5 to 200 μm.

[7] A method of manufacturing a sheet for capacitor electrodes, the method comprising the steps of:

atomizing molten alloy including one or more valve metals selected from the group consisting of Ti, Zr, Nb, Hf and Ta, and Al into atomized molten alloy; and

applying the atomized molten alloy on at least one surface of a foil-like core material containing at least one metal selected from the group consisting of Al, Ti, Zr, Nb, Hf and Ta as a main ingredient.

[8] A method of manufacturing a sheet for capacitor electrodes, the method comprising the steps of:

atomizing molten alloy including one or more valve metals selected from the group consisting of Ti, Zr, Nb, Hf and Ta, and Al into atomized molten alloy;

applying the atomized molten alloy on at least one surface of a foil-like core material containing at least one metal selected from the group consisting of Al, Ti, Zr, Nb, Hf and Ta as a main ingredient to obtain a laminate sheet; and

rolling the laminate sheet.

[9] The method of manufacturing a sheet for capacitor electrodes as recited in the aforementioned Item [8], wherein the laminate sheet is rolled at a rolling reduction ratio of 2 to 60%.

[10] The method of manufacturing a sheet for capacitor electrodes as recited in any one of the aforementioned Items [7] to [9], wherein in the step of obtaining the laminate sheet the atomized alloy is jetted to at least one surface of the core material in an inert gas atmosphere to fix the atomized alloy thereto.

[11] The method of manufacturing a sheet for capacitor electrodes as recited in any one of the aforementioned Items [7] to [10], wherein in the step of obtaining the laminate sheet the atomized alloy is fixed on both surfaces of the core material simultaneously.

[12]A method of manufacturing a sheet for capacitor electrodes, the method comprising the steps of:

atomizing molten alloy including one or more valve metals selected from the group consisting of Ti, Zr, Nb, Hf and Ta, and Al into atomized molten alloy; and

applying the atomized molten alloy on one surface of a foil-like core material containing at least one metal selected from the group consisting of Al, Ti, Zr, Nb, Hf and Ta as a main ingredient, and cooling the core material with the alloy by bringing a cooling roll into contact with the other surface of the core material concurrently with or after the application step of the atomized molten alloy to obtain a laminate sheet.

[13] A method of manufacturing a sheet for capacitor electrodes, the method comprising the steps of:

atomizing molten alloy including one or more valve metals selected from the group consisting of Ti, Zr, Nb, Hf and Ta, and Al into atomized molten alloy;

applying the atomized molten alloy on one surface of a foil-like core material containing at least one metal selected from the group consisting of Al, Ti, Zr, Nb, Hf and Ta as a main ingredient, and cooling the core material with the alloy by bringing a cooling roll into contact with the other surface of the core material concurrently with or after the application step of the atomized molten alloy to obtain a laminate sheet; and

rolling the laminate sheet.

[14] The method of manufacturing a sheet for capacitor electrodes as recited in the aforementioned Item [13], wherein the laminate sheet is rolled at a rolling reduction ratio of 2 to 60%.

[15] The method of manufacturing a sheet for capacitor electrodes as recited in any one of the aforementioned Items [12] to [14], wherein in the step of obtaining the laminate sheet the atomized alloy is jetted on at least one surface of the core material in an inert gas atmosphere to fix thereon.

[16] A method of manufacturing a sheet for capacitor electrodes, the method, comprising:

spraying atomized molten alloy including one or more valve metals selected from the group consisting of Ti, Zr, Nb, Hf and Ta, and Al approximately downward;

injecting an inert gas flow against the spray flow to generate a branched spray flow of the atomized alloy from the spray flow;

jetting the branched spray flow against a foil-like core material including one metal selected from the group consisting of Al, Ti, Zr, Nb, Hf and Ta as a main ingredient to fix the atomized alloy on at least one surface of the core material to obtain a laminate sheet.

[17] The method of manufacturing a sheet for capacitor electrodes as recited in the aforementioned Item [16], wherein the laminate sheet is rolled at a rolling reduction ratio of 2 to 60%.

[18] A method of manufacturing a sheet for capacitor electrodes, the method, comprising:

spraying atomized molten alloy including one or more valve metals selected from the group consisting of Ti, Zr, Nb, Hf and Ta, and Al approximately downward;

injecting an inert gas flow against the spray flow in an approximately horizontal direction to generate a branched spray flow of the atomized alloy from the spray flow in an approximately horizontal direction;

jetting the branched spray flow against a foil-like core material including one metal selected from the group consisting of Al, Ti, Zr, Nb, Hf and Ta as a main ingredient to fix the atomized alloy which is being transferred in an approximately up-and-down direction on at least one surface of the core material to obtain a laminate sheet; and

rolling the laminate sheet.

[19] The method of manufacturing a sheet for capacitor electrodes as recited in any one of the aforementioned Items [16] to [18], further comprising the step of:

cooling the core material with the alloy by bringing a cooling roll into contact with one surface of the core material concurrently with or after the application step of the atomized molten alloy on the other surface of the core material to obtain a laminate sheet.

[20] The method of manufacturing a sheet for capacitor electrodes as recited in any one of the aforementioned Items [16] to [19], wherein a flow rate of the inert gas atmosphere is set to 350 to 1,000 m/sec.

[21] The method of manufacturing a sheet for capacitor electrodes as recited in any one of the aforementioned Items [10], [11], [15] to [20], wherein the atomized alloy is jetted against the core material at an incident angle of 15° to 90°.

[22] The method of manufacturing a sheet for capacitor electrodes as recited in any one of the aforementioned Items [5] to [21], wherein the molten alloy is a molten alloy consisting essentially of Zr: 3 to 20 atomic %, aluminum and inevitable impurities.

[22] The method of manufacturing a sheet for capacitor electrodes as recited in any one of the aforementioned Items [5] to [23], wherein the molten alloy is a molten alloy consisting essentially of Nb: 3 to 20 atomic %, aluminum and inevitable impurities.

[24] The method of manufacturing a sheet for capacitor electrodes as recited in any one of the aforementioned Items [5] to [23], wherein atomizing the molten alloy is performed by injecting an injection airflow against a flow of molten alloy particles.

[25] The method of manufacturing a sheet for capacitor electrodes as recited in any one of the aforementioned Items [7] to [24], wherein an average particle diameter of the atomized alloy to be fixed to the core material is 0.5 to 200 μm.

[26] The method of manufacturing a sheet for capacitor electrodes as recited in any one of the aforementioned Items [7] to [25], wherein an aluminum foil or an alloy foil including one or more valve metals selected from the group consisting of Ti, Zr, Nb, Hf and Ta, and Al is used as the core material.

[27] A method of manufacturing an anode material for electrolytic capacitors, the method, comprising:

etching the sheet for electrodes obtained by the method as recited in any one of the aforementioned Items [5] to [26]; and thereafter

performing a forming of the etched sheet to form a dielectric film on the surface thereof.

[28] An anode material for electrolytic capacitors manufactured by the method as recited in the aforementioned Item [27].

[29] A method of manufacturing an anode material for electrolytic capacitors, the method, comprising the steps of:

etching the sheet for electrodes as recited in the aforementioned Items 1 to 4; and thereafter

performing a forming of the etched sheet to form a dielectric film on the surface thereof.

[30] An anode material for electrolytic capacitors manufactured by the method as recited in the aforementioned Item [29].

[31] An electrolytic capacitor constituted by the anode material as recited in the aforementioned Item [28] or [30].

[32] An apparatus for manufacturing a sheet for capacitor electrodes, comprising:

an airflow generator which generates an airflow;

a supporter disposed at a leeward side of the airflow generated by the airflow generator; and

a molten alloy storing tank having a spraying aperture, the molten alloy storing tank being disposed above an intermediate position between the supporter and the molten alloy storing tank. [33] The apparatus for manufacturing a sheet for capacitor electrodes as recited in the aforementioned Item [32], wherein the airflow generator is an apparatus for generating an airflow in an approximately horizontal direction.

[34] The apparatus for manufacturing a sheet for capacitor electrodes as recited in the aforementioned Item [32] or [33], further comprising a pair of reduction rolls.

[35] The apparatus for manufacturing a sheet for capacitor electrodes as recited in any one of the aforementioned Items [32] to [34], further comprising a shielding plate disposed at a position below the spraying aperture of the molten alloy storing tank.

[36] The apparatus for manufacturing a sheet for capacitor electrodes as recited in any one of the aforementioned Items [32] to [35], wherein cooling rolls are used as the supporter.

According to the invention as recited in the aforementioned Item [1], the porous layer includes an intermetallic compound made of a certain valve metal(s) and Al, and the oxide film to be made by subjecting it to a forming is extremely large in dielectric constant. Therefore, large capacitance can be obtained. Furthermore, since the porosity of the porous layer is 10% or above, the contact surface area for electrolytic solution increases, which in turn results in further increased capacitance. Furthermore, since the porous layer is constituted such that particles of the intermetallic compound are fixed in solid solution in which the valve metal(s) are dissolved in Al, sufficient ductility can be obtained, resulting in excellent bent-resistant performance and calking-resistant performance. Accordingly, utilizing the sheet for electrodes according to the present invention makes it possible to provide rolled type electrolytic capacitors for example. In an electrolytic capacitor employing this sheet for electrodes, the equivalent series resistance (ESR value) can be held small.

In the invention as recited in the aforementioned Item [2], the porous layer includes an intermetallic compound made of a certain valve metal(s) and Al, and the oxide film to be made by subjecting it to a forming is extremely large in dielectric constant. Therefore, large capacitance can be obtained. Furthermore, since the porosity of the porous layer is 10% or above, the contact surface area for electrolytic solution increases, which in turn results in further increased capacitance. Furthermore, since the porous layer is integrally formed on the core material in a laminated manner, sufficient strength can be obtained. Furthermore, since the porous layer is constituted such that particles of the intermetallic compound are fixed in solid solution in which the valve metal(s) are dissolved in Al, sufficient ductility can be obtained, resulting in excellent bent-resistant performance and calking-resistant performance. Accordingly, utilizing the sheet for electrodes according to the present invention makes it possible to provide rolled type electrolytic capacitors for example. In an electrolytic capacitor employing this sheet for electrodes, the equivalent series resistance (ESR value) can be held small.

In the invention as recited in the aforementioned Item [3], the sheet strength and the bent-resistant performance can be further increased while keeping the large capacitance.

In the invention as recited in the aforementioned Item [4], the sheet strength can be further increased while keeping the large capacitance.

In the invention as recited in the aforementioned Item [5], a porous sheet in which particles of an intermetallic compound made of certain valve metals and Al are fixed in solid solution in which the valve metals are dissolved in Al can be obtained. Therefore, it is possible to manufacture a sheet for electrodes having large capacitance and excellent in bent-resistant performance.

In the invention as recited in the aforementioned Item [6], since the average particle diameter of the atomized alloy is 0.5 to 200 μm, it is possible to manufacture a sheet for electrodes capable of obtaining larger capacitance.

In the invention as recited in the aforementioned Item [7], a sheet in which a porous layer is integrally formed on a core material such as an aluminum core material can be obtained, and the porous layer is constituted such that particles of the intermetallic compound made by certain valve metals and Al are fixed in solid solution in which the valve metal(s) are dissolved in Al. Therefore, it is possible to manufacture a sheet for electrodes large in capacitance and excellent in bent-resistance performance.

In the invention as recited in the aforementioned Item [8], since the method further includes the step of rolling the laminate sheet, it is possible to manufacture a sheet for electrodes having sufficient strength.

In the invention as recited in the aforementioned Item [9], since the laminate sheet is rolled at a rolling reduction ratio of 2 to 60%, it is possible to manufacture a sheet for electrodes having larger capacitance and further increased strength.

In the invention as recited in the aforementioned Item [10], since the atomized alloy is jetted against at least one surface of the core material in an inert gas atmosphere to fix the atomized alloy thereto, it is possible to prevent the oxidation reaction, etc., of the core material and/or the atomized alloy. This notably enhances the quality of the sheet for electrodes to be obtained. Furthermore, in this method, since the atomized alloy is “jetted” against the core material to fix the alloy thereto, more atomized alloy can be “forcibly” fixed to the boundary region of the core material, resulting in sufficient bonding strength between the core material and the porous layer.

In the invention as recited in the aforementioned Item [11], since in the step of obtaining the laminate sheet the atomized alloy is fixed on both surfaces of the core material simultaneously, there are merits that the manufacturing efficiency can be improved and no supporter for supporting the core material is required.

In the invention as recited in the aforementioned Item [12], a sheet in which a porous layer is integrally formed on a core material such as an aluminum core material can be obtained, and the porous layer is constituted such that particles of the intermetallic compound made by certain valve metals and Al are fixed in solid solution in which the valve metal(s) are dissolved in Al. Therefore, it is possible to manufacture a sheet for electrodes large in capacitance and excellent in bent-resistance performance. Furthermore, the cooling the core material with the alloy is performed by bringing a cooling roll into contact with the other surface of the core material concurrently with or after the application step of the atomized molten alloy. Therefore, the atomized alloy adhering to the core material can be cooled sufficiently and forcibly concurrently with or after the application step of the atomized molten alloy, resulting in further improved bonding strength between the core material and the porous layer.

In the invention as recited in the aforementioned Item [13], since the method further includes the step of rolling the laminate sheet, it is possible to manufacture a sheet for electrodes having sufficient strength.

In the invention as recited in the aforementioned Item [14], since the laminate sheet is rolled at a rolling reduction ratio of 2 to 60%, it is possible to manufacture a sheet for electrodes having larger capacitance and further increased strength.

In the invention as recited in the aforementioned Item [15], since the atomized alloy is jetted against at least one surface of the core material in an inert gas atmosphere to fix the atomized alloy thereto, it is possible to prevent the oxidation reaction, etc., of the core material and/or the atomized alloy. This notably enhances the quality of the sheet for electrodes to be obtained. Furthermore, in this method, since the atomized alloy is “jetted” against the core material to fix the alloy thereto, more atomized alloy can be “forcibly” fixed to the boundary region of the core material, resulting insufficient bonding strength between the core material and the porous layer.

In the invention as recited in the aforementioned Item [16], the sheet in which a porous layer is integrally formed on the core material such as an aluminum core material can be obtained, and the porous layer is constituted such that particles of the intermetallic compound made by certain valve metals and Al are fixed in solid solution in which the valve metal(s) are dissolved in Al. Therefore, it is possible to manufacture a sheet for electrodes large in capacitance and excellent in bent-resistance performance. In the method as recited in the aforementioned Item [16], the atomized alloy sprayed approximately downward is not jetted to the core material as it is. The method is characterized in that an inert gas flow is jetted against the spray flow to generate a branched spray flow of the atomized alloy from the spray flow and the branched spray flow is jetted against the core material. Although the atomized alloy constituting the spray flow sprayed approximately downward has a certain particle diameter range, the atomized alloy relatively small in particle diameter will generate a branched spray flow by the inert gas flow, while the atomized alloy relatively large in particle diameter is large in mass and therefore will drip as it is. Therefore, it is possible to selectively jet only the atomized alloy small in particle diameter against the core material. Accordingly, a porous layer having a larger surface area can be formed on at least one surface of the core material.

In the invention as recited in the aforementioned Item [17], since the laminate sheet is rolled at a rolling reduction ratio of 2 to 60%, it is possible to manufacture a sheet for electrodes having larger capacitance and further increased strength.

In the invention as recited in the aforementioned Item [18], the sheet in which a porous layer is integrally formed on the core material such as an aluminum core material can be obtained, and the porous layer is constituted such that particles of the intermetallic compound made by certain valve metals and Al are fixed in solid solution in which the valve metal(s) are dissolved in Al. Therefore, it is possible to manufacture a sheet for electrodes large in capacitance and excellent in bent-resistance performance. In the method as recited in the aforementioned Item [18], the atomized alloy sprayed approximately downward is not jetted to the core material as it is. The method is characterized in that an inert gas flow is jetted against the spray flow to generate a branched spray flow of the atomized alloy from the spray flow and the branched spray flow is jetted against the core material. Although the atomized alloy constituting the spray flow sprayed approximately downward has a certain particle diameter range, the atomized alloy relatively small in particle diameter will generate a branched spray flow by the inert gas flow, while the atomized alloy relatively large in particle diameter is large in mass and therefore will drip as it is. Therefore, it is possible to selectively jet only the atomized alloy small in particle diameter against the core material. Accordingly, a porous layer having a larger surface area can be formed on at least one surface of the core material. Furthermore, since this method employs the structure in which a branched spray flow is generated and the branched spray flow is jetted against a foil-like core material which is being transferred in an approximately up-and-down direction, it is possible to assuredly cause the atomized alloy relatively large in particle diameter to be dropped. As a result, only the atomized alloy small in particle diameter can be jetted against the core material.

In the invention as recited in the aforementioned Item [19], since the atomized alloy is cooled by bringing a cooling roll into contact with the core material concurrently with or after the application step of the atomized molten alloy, the atomized alloy adhering to the core material can be sufficiently and forcibly cooled concurrently with or after the adhesion of the alloy, resulting in further increased bonding strength between the core material and the porous layer.

In the invention as recited in the aforementioned Item [20], since the flow rate of the inert gas atmosphere is set to 350 to 1,000 m/sec., it is possible to assuredly cause the atomized alloy relatively large in particle diameter to be dropped. As a result, only the atomized alloy small in particle diameter can be jetted against the core material.

In the invention as recited in the aforementioned Item [21], since the atomized alloy is jetted against the core material at an incident angle of 15° to 90°, almost all of the atomized alloy jetted to the core material can be fixed to the core material, which improves the manufacturing efficiency and decreases the manufacturing cost.

In the invention as recited in the aforementioned Item [22], since as the material of the molten alloy an alloy having a special composition among Al—Nb series alloys is used, capacitance can be further increased.

In the invention as recited in the aforementioned Item [23], since as the material of the molten alloy an alloy having a special composition among Al—Nb series alloys is used, capacitance can be further increased.

In the invention as recited in the aforementioned Item [24], since atomizing the molten alloy is performed by injecting an injection airflow against a flow of molten alloy particles, the molten alloy can be atomized efficiently. Furthermore, the atomized alloy can be equal in density, which enables manufacturing of a sheet for electrodes of the same quality.

In the invention as recited in the aforementioned Item [25], the average particle diameter of the atomized alloy is 0.5 to 200 μm, it is possible to manufacture a sheet for electrodes capable of obtaining larger capacitance.

In the invention as recited in the aforementioned Item [26], since an aluminum foil or the aforementioned specific alloy foil is used as the core material, there is a merit that there is less film defect at the time of the forming and therefore leakage current can be decreased.

In the invention as recited in the aforementioned Item [27], since the surface area of the porous layer can be increased by etching and an oxide film having a large dielectric constant can be formed by forming, it becomes possible to provide an electrolytic capacitor having larger capacitance.

Since the anode material for electrolytic capacitors according to the aforementioned Item [28] can attain larger capacitance and is excellent in bent-prevention performance, the use of this anode material makes it possible to provide, for example, a roll-type electrolytic capacitor small in size and large in capacity.

In the invention as recited in the aforementioned Item [29], since the surface area of the porous layer can be increased by etching and an oxide film having a large dielectric constant can be formed by forming, it becomes possible to provide an electrolytic capacitor having larger capacitance.

Since the anode material for electrolytic capacitors according to the aforementioned Item [30] can attain larger capacitance and is excellent in bent-prevention performance, the use of this anode material makes it possible to provide, for example, a roll-type electrolytic capacitor small in size and large in capacity.

In the invention as recited in the aforementioned Item [31], since the electrolytic capacitor is constituted by the anode material as recited in Item [27] or [29], an electrolytic capacitor small in size and large in capacitance can be provided. In this electrolytic, the series resistance (ESR value) can be held small. Furthermore, the anode material as recited in Item [27] or [29] is excellent in bent-resistance performance, and therefore it becomes possible to provide, for example, a roll-type electrolytic capacitor small in size and large in capacity.

In the invention as recited in the aforementioned Item [32], since the apparatus is provided with an airflow generator, a supporter and a molten alloy storing tank having a spraying aperture, the atomized alloy sprayed from the molten alloy storing tank can be jetted against the core material, and therefore the porous layer of the obtained laminate sheet can be constituted such that particles of the intermetallic compound are fixed in solid solution in which the valve metal(s) are dissolved in Al. Therefore, it is possible to manufacture a sheet for electrodes large in capacitance and excellent in bent-resistance performance. Furthermore, in this apparatus, the sprayed atomized alloy is not jetted against the core material as it is. An inert gas flow is jetted against the spray flow to generate a branched spray flow of the atomized alloy from the spray flow and the branched spray flow is jetted against the core material. Therefore, it is possible to selectively jet only the atomized alloy small in particle diameter against the core material.

In the invention as recited in the aforementioned Item [33], since the airflow generator generates an airflow approximately in a horizontal direction, only the atomized alloy small in particle size can be selectively made into the branch spray flow, which in turn enables only the atomized alloy small in particle size to be jetted against the core material assuredly.

In the invention as recited in the aforementioned Item [34], since the obtained laminate sheet can be rolled, it is possible to manufacture a sheet for electrodes having sufficient strength.

In the invention as recited in the aforementioned Item [35], since the apparatus is further provided with a shielding plate, it is possible to assuredly prevent that the atomized alloy (atomized alloy having relatively large particle diameter) dropped without making a branched spray flow adheres to the core material. Accordingly, a sheet for electrodes of high quality can be manufactured stably.

In the invention as recited in the aforementioned Item [36], since the structure is that cooling rolls are used as the supporter, the atomized alloy adhering to the core material can be cooled forcibly and sufficiently, which enables to manufacture a sheet for electrodes having increased bonding strength between the core material and the porous layer.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWINGS

The preferred embodiments of the present invention are shown by way of example, and not limitation, in the accompanying figures, in which:

FIG. 1A is a schematic cross-sectional view showing a sheet for electrodes according to an embodiment of the present invention;

FIG. 1B is a schematic cross-sectional view showing a sheet for electrodes according to another embodiment of the present invention;

FIGS. 2A and 2B are a schematic cross-sectional view showing an anode material for electrolytic capacitors according to an embodiment of the present invention respectively;

FIG. 3 is a schematic view showing an example of a manufacturing method (manufacturing apparatus) according to the present invention;

FIG. 4 is a schematic view showing another example of a manufacturing method (manufacturing apparatus) according to the present invention;

FIG. 5 is a schematic view showing a still another example of a manufacturing method (manufacturing apparatus) according to the present invention;

FIG. 6 is a schematic view showing a still yet another example of a manufacturing method (manufacturing apparatus) according to the present invention;

FIG. 7 is an explanatory view of the incident angle of the jetting of the atomized alloy;

FIG. 8 is an explanatory view showing an evaluation method of bent-prevention performance; and

FIG. 9 is an enlarged cross-sectional view showing a sheet for electrodes pinched with pinching jigs.

### BEST MODE FOR CARRYING OUT THE INVENTION

In the following paragraphs, some preferred embodiments of the invention will be described by way of example and not limitation. It should be understood based on this disclosure that various other modifications can be made by those in the art based on these illustrated embodiments.

A sheet 1 for capacitor electrodes according to the present invention is a sheet provided with a porous layer 4 including an intermetallic compound made of one or more valve metals selected from the group consisting of Ti, Zr, Nb, Hf and Ta, and Al. The sheet 1 can be constituted only by the porous layer 4. Alternatively, the sheet 1 can be constituted by a core material 3 and one or a plurality of porous materials 4 laminated on the core material 3.

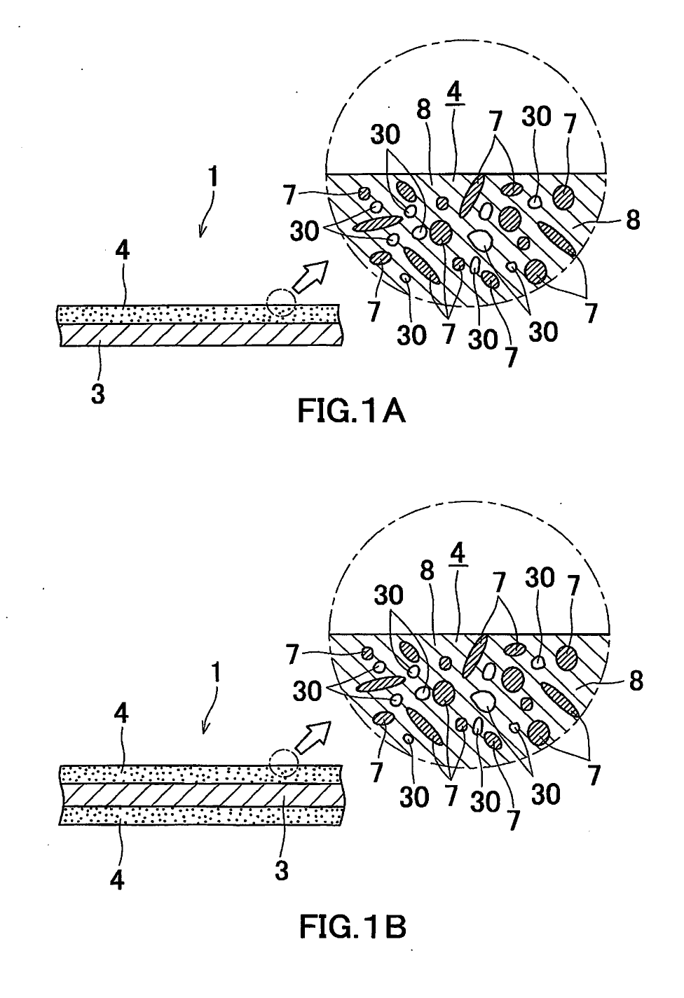

One embodiment of the sheet 1 for capacitor electrodes according to the present invention is shown in FIG. 1A. This sheet 1 for capacitor electrodes is a sheet in which a porous layer 4 is integrally formed on one surface of a foil-like core material 3. This porous layer 4 includes an intermetallic compound made of one or more valve metals selected from the group consisting of Ti, Zr, Nb, Hf and Ta, and Al.

Another embodiment of the sheet 1 for capacitor electrodes according to the present invention is shown in FIG. 1B. This sheet 1 for capacitor electrodes has the same structure as in the aforementioned embodiment except that porous layers 4 and 4 are integrally formed on both surfaces of a foil-like core material 3. These porous layers 4 include an intermetallic compound made of one or more valve metals selected from the group consisting of Ti, Zr, Nb, Hf and Ta, and Al, respectively.

In the sheet 1 for capacitor electrodes according to the present invention, as shown in FIGS. 1A and 1B, the porous layer 4 is constituted such that particles 7 of the intermetallic compound are fixed in solid solution 8 in which the one or more valve metals are dissolved in Al. The particles 7 are fixed via the solid solution 8, and therefore the sheet 1 for electrodes becomes sufficient in ductility and excellent in bent-resistant performance. The solid solution 8 can include second phase particles therein so long as sufficient ductility can be obtained.

The reference numeral “30” denotes a pore existing within the porous layer 4. This pore 30 can be a closed cell type pore not communicated with another pores or outside, a continuous cell type pore communicated with another pores or outside, or a combination thereof.

In the sheet for capacitor electrodes according to the present invention, it is necessary that the porosity of the porous layer is 10% or above. If the porosity is less than 10%, the surface area becomes too small, resulting in insufficient capacitance for a sheet 1 for electrodes. It is preferable that the porosity of the porous layer 4 is 10 to 75%. The more preferable range is 35 to 65%.

As the aforementioned intermetallic compound, an intermetallic compound made of one or more valve metals selected from the group consisting of Ti, Zr, Nb, Hf and Ta, and Al is used. Concrete examples thereof include Ti—Al intermetallic compound, Zr—Al intermetallic compound, Nb—Al intermetallic compound, Hf—Al intermetallic compound, Ta—Al intermetallic compound, Ti—Zr—Al intermetallic compound, Ti—Zr—Nb—Al intermetallic compound, and Ti—Zr—Nb—Hf—Al intermetallic compound. However, the intermetallic compound according to the present invention is not limited to one of them.

As the aforementioned Zr—Al intermetallic compound, ZrAl, Zr₂Al₃, ZrAl₂ and ZrAl₃ can be exemplified, but not limited to one of them. Furthermore, as the aforementioned Nb—Al intemetallic compound, Nb₃Al, Nb₂Al, and NbAl₃ can be exemplified, but not limited to one of them.

In the present invention, as the aforementioned core material 3, a core material containing at least one metal selected from the group consisting of Al, Ti, Zr, Nb, Hf, and Ta as a main ingredient is used. Examples include a foil made of a single metal such as a Ti foil, a Zr foil, a Nb foil, a Hf foil, a Ta foil, or an aluminum foil. Examples of the aluminum foil include an Al foil, an Al—Ti series foil, an Al—Zr series foil, an Al—Nb series foil, an Al—Hf series foil, and an Al—Ta series foil. As the core material 3, it is preferable to use an Al foil, or an alloy foil made of one or more valve metals selected from the group consisting of Ti, Zr, Nb, Hf and Ta, and Al, which remarkably can reduce leakage current. When any one of a Ti foil, a Zr foil, a Nb foil and a Hf foil is used, the strength of the sheet 1 can be increased, and the leakage current can be decreased.

It is preferable that the thickness of the core material 3 is 5 to 80 μm. If it is less than 5 μm, sufficient strength as a sheet for electrodes cannot be obtained and therefore it is not preferable. On the other hand, if it exceeds 80 μm, it becomes difficult to meet the demand of weight saving and downsizing and therefore it is not preferable. Among other things, it is more preferable that the thickness of the core material is 10 to 60 μm.

The thickness of the porous layer 4 is preferably 5 to 300 μm. If the thickness is less than 5 μm, it is not preferable because sufficient capacitance as a sheet for electrodes cannot be obtained. On the other hand, if it exceeds 300 μm, it becomes difficult to meet the demand of weight saving and downsizing and therefore it is not preferable. Among other things, it is more preferable that the thickness of the core material is 10 to 200 μm.

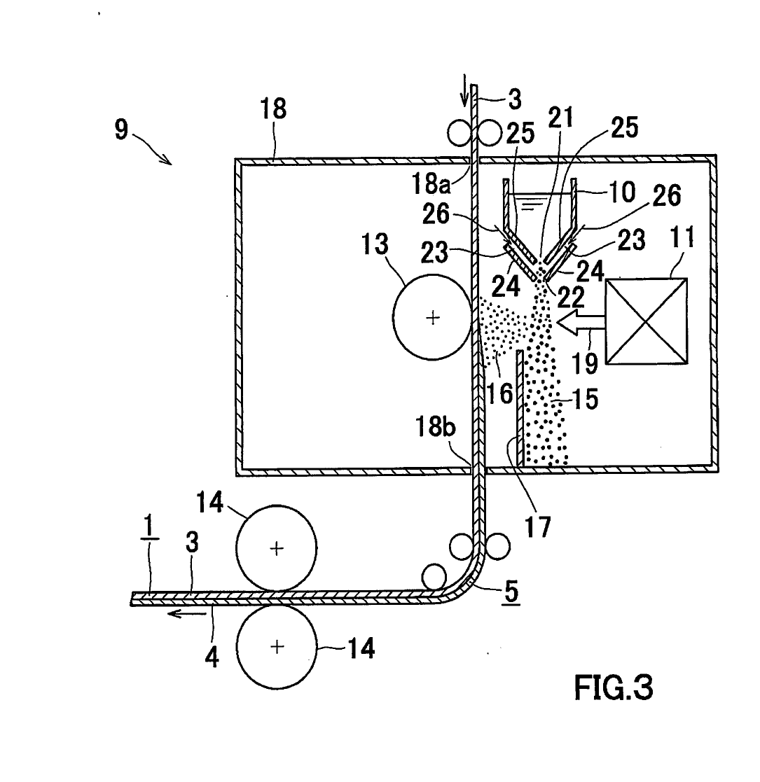

A manufacturing apparatus 9 for manufacturing a sheet for capacitor electrodes will be explained with reference to FIG. 3. In this manufacturing apparatus 9, the reference numeral “10” denotes a molten alloy storing tank, “11” denotes an airflow generator, “13” denotes a cooling roll, “14” denotes reduction rolls and “17” denotes a shielding plate. Among these parts, the molten alloy storing tank 10, the airflow generator 11, the cooling roll 13 and the shielding plate 17 are disposed in a box 18. The inside of the box 18 is set to be an inert gas atmosphere.

The box 18 is provided with an upper sheet insertion slit 18a at the upper wall and a lower sheet insertion slit 18b at the bottom wall so as to be disposed right below the upper sheet insertion slit 18a. Thus, a foil-like aluminum core material 3 to be supplied passes through the upper sheet insertion slit 18a from above the upper wall of the box 18 and advances downward in the inner space of the box 18, and then goes out of the box via the lower sheet insertion slit 18b of the bottom wall of the box 18.

The airflow generator 11 is an apparatus for generating an airflow approximately in the horizontal direction. That is, the driving of this apparatus causes an inner gas flow to be forwarded approximately in a horizontal direction at a constant flow rate.

The cooling roll 13 is disposed at the leeward of the airflow generated by the airflow generator 11. In other words, the cooling roll 13 is disposed at approximately the same height position as the airflow generator 11. This cooling roll 13 supports the aluminum core material 3 so as not to be moved toward the left side of the drawing when the atomized alloy (molten alloy) is jetted against the aluminum core material 3, and also cools the aluminum core material 3 in contact with the cooling roll 13. This cooling can enhance the cooling and fixing of the atomized molten alloy adhering to the aluminum alloy 3. In this embodiment, as the cooling roll 13, a water-cooling type roll is employed.

The aforementioned molten alloy storing tank 10 is disposed at a position above the central position between the cooling roll 13 and the airflow generator 11. At the lower side of a first bottom wall 25 of the molten alloy storing tank 10, a second bottom wall 24 is provided so as to form an air passage therebetween. Provided at the central portion of the first bottom wall 25 is an opening 21, and provided at the central portion of the second bottom wall 24 is a spraying aperture 22. In this embodiment, the spraying aperture 22 is provided at a position immediately below the opening 21. In the air passage 23, a spraying airflow 26 is generated in the direction of the arrow shown in FIG. 3. This spraying airflow 26 is given by an airflow generator (not shown).

Thus, the rill of molten alloy is jetted via the opening 21 of the molten alloy storing tank 10, and the spraying airflow 26 is injected to the rill of molten alloy concurrently with the jetting of the rill of molten alloy. This causes the molten alloy to be atomized. The atomized molten alloy is sprayed as an atomized spray flow 15 downward via the spraying aperture 22. An inert gas flow 19 generated by the airflow generator 11 is injected against the spray flow 15 sprayed downward. As a result, a branched spray flow 16 of the atomized alloy is generated approximately in a horizontal direction. This branched spay flow 16 is jetted against the aluminum core material 3 which is being transferred downward. Concurrently with this jetting of the branched spray flow 16, the aluminum core material 3 is cooled by the cooling roll 13, which enhances the cooling and fixing of the atomized alloy on the core material. Thus, a laminate sheet 5 is obtained.

The aforementioned shielding plate 17 stands on the bottom wall of the box 18 vertically upward. The standing position thereof is shifted from a position right below the spraying aperture 22 of the molten alloy storing tank 10 toward the side of the cooling roll 13. The height of the shielding plate 17 is set so as not to block the inert gas flow 19. As a result, it is prevented that the spray flow other than the branched spray flow 16, which drops at it is, reaches and adheres to the surface of the laminate sheet 5.

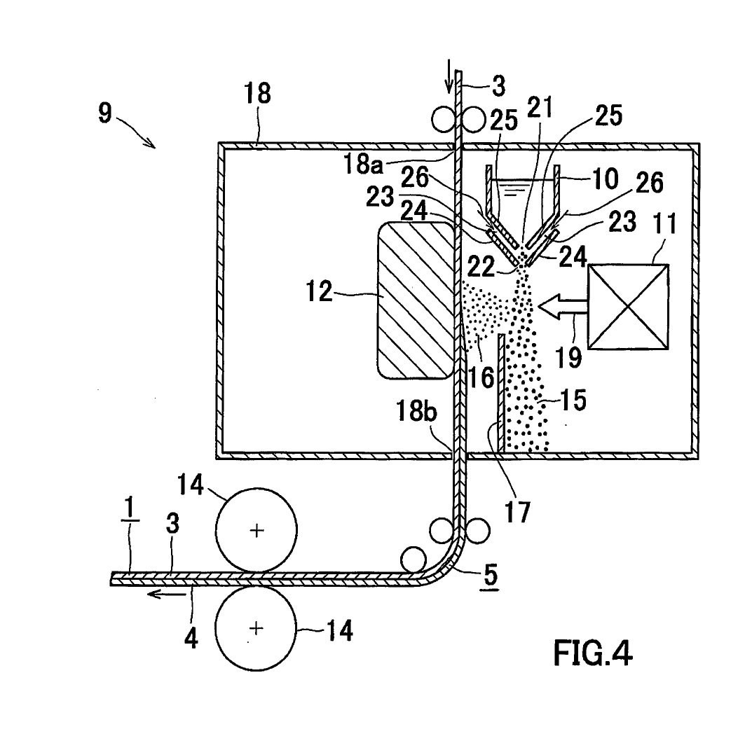

The pair of reduction rolls 14 and 14 are disposed outside the box 18. The laminate sheet 5 transferred through the lower sheet insertion slit 18b formed in the bottom wall of the box 18 is introduced between the reduction rolls 14 and 14 to be rolled. Thus, a sheet 1 for electrodes according to the present invention is manufactured. In the aforementioned embodiment, as shown in FIG. 4, in place of the cooling roll 13, a supporter 12 such as a supporting plate can be disposed. This supporter 12 can support the aluminum core material 3 so as not to be moved at the time of being jetted by the atomized alloy (molten alloy).

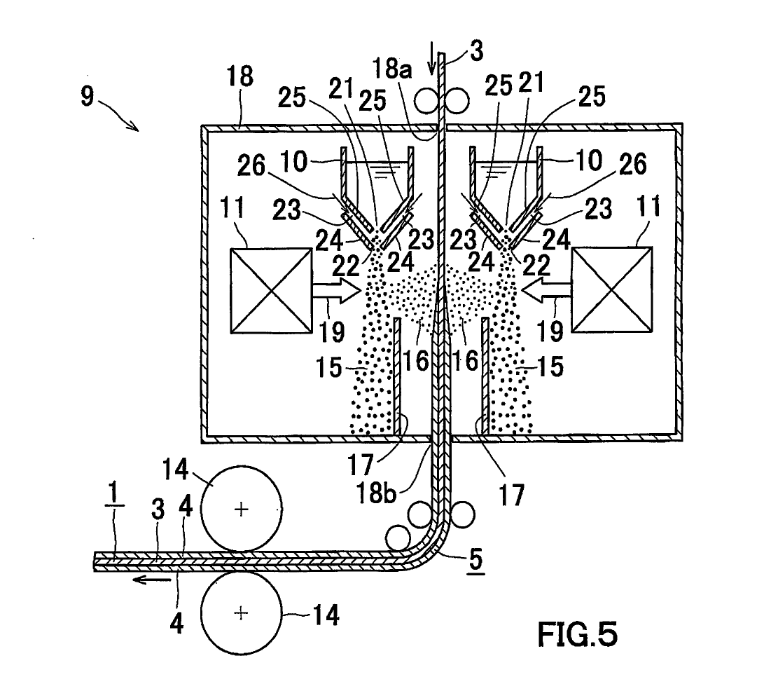

Another embodiment of a manufacturing apparatus 9 for manufacturing a sheet for capacitor electrodes according to the present invention will be explained with reference to FIG. 5. Regarding the same structure as in the aforementioned embodiment, the explanation will be omitted by allotting the same reference numeral. In this manufacturing apparatus 9 shown in FIG. 5, in place of the cooling roll 13 of the manufacturing apparatus as shown in FIG. 3, in this left space, a molten alloy storing tank 10, an airflow generator 11 and a shielding plate 17 are disposed in the same manner as in the right space. As shown in FIG. 5, in this apparatus, the parts are disposed symmetrically with respect to the centrally positioned aluminum core material 3. Other structures are the same as those of the aforementioned embodiment (the apparatus shown in FIG. 3).

With this apparatus 9, branched spray flows 16 and 16 of the atomized alloy are jetted against both sides of the same position of the aluminum core material 3 by the inert gas flows generated by the airflow generators 11 and 11. Therefore, without the cooling roll or the supporter 12 such as a supporting plate, the movement of the aluminum core material 3 in the right and left directions due to the injection of the branched spray flows can be prevented. Furthermore, in the apparatus 9, the atomized molten alloy can be jetted against the same height position of both sides of the aluminum core material 3, which can reduce the apparatus mounting space and enables an efficient formation of porous layers 4 and 4 on both sides of the aluminum core material 3.

Next, a method of manufacturing a sheet for capacitor electrodes according to the present invention will be explained. Initially, molten alloy including one or more valve metals selected from the group consisting of Ti, Zr, Nb, Hf and Ta, and Al is supplied in a molten alloy storing tank 10. The airflow generator 11 is activated, and a foil-like aluminum core material 3 is introduced into the box 18 via the sheet insertion slit 18a and transferred downward within the box 18. At the same time, a spraying airflow 26 is flowed into the air passage 23 of the molten alloy storing tank 10 in the direction of the arrow shown in FIG. 3 to inject the spraying airflow 26 against the rill of the molten alloy poured from the opening 21 to thereby jet a spray flow 15 of atomized alloy (molten alloy) downward from the spraying aperture 22. Since the inside of the box 18 is filled with an inert gas, the spraying airflow 26 is an inert gas flow.

At this time, the inert gas flow 19 generated by the airflow generator 11 is injected approximately horizontally against the downward spray flow 15. This generates an approximately horizontal branched spray flow 16 of the atomized alloy from the spray flow 15. This branched spray flow 16 is jetted against one side of the aluminum core material 3 which is being transferred downward. The atomized alloy constituting the spray flow 15 sprayed downward has a certain distribution range of particle size. Among the atomized alloy, atomized alloy relatively small in particle size forms the approximately horizontal branched spray flow 16 by the insert gas flow 19, while the atomized alloy relatively large in particle size goes down due to the large mass. Accordingly, the adoption of this spraying method enables the atomized alloy small in particle size among the spray flow 15 to be selectively jetted and fixed to the aluminum alloy core 3, and therefore a porous layer 4 large in surface area can be formed on one side of the aluminum core material 3.

Furthermore, in this embodiment, concurrently with the jetting of the branched spray flow 16 against one side of the aluminum core material 3, the cooling is performed by bringing the cooling roll 13 into contact with the other side of the aluminum core material 3 to obtain a laminate sheet 5. This enhances the cooling and fixing of the atomized molten alloy to the aluminum core material 3.

The obtained laminate sheet 5 in which the atomized alloy is formed on one side of the aluminum core material 3 is introduced between the pair of reduction rolls 14 and 14, to thereby obtain the sheet 1 for electrodes according to the present invention. That is, a sheet 1 for electrodes configured such that the porous layer 4 is formed on one side of the aluminum core material 3 can be obtained.

In this embodiment, concurrently with the jetting of the atomized alloy against one side of the aluminum core material 3, the cooling roll 13 is brought into contact with the other side of the aluminum core material 3. However, the cooling using the cooling roll 13 can be performed after the adhesion of the atomized alloy to the aluminum core material 3.

Furthermore, in the embodiment, although the atomized alloy is jetted against one side of the aluminum core material 3, the atomized alloy can be jetted against and fixed to both sides of the aluminum core material 3 to obtain the sheet 1 for electrodes.

Next, another method of manufacturing a sheet for capacitor electrodes will be explained with reference to FIG. 5. Initially, molten alloy including one or more valve metals selected from the group consisting of Ti, Zr, Nb, Hf and Ta, and Al is supplied in the right and left molten alloy storing tanks 10, respectively. Both the airflow generators 11 are activated, and a foil-like aluminum core material 3 is introduced into the box 18 via the sheet insertion slit 18a and transferred downward within the box 18. At the same time, a spraying airflow 26 is flowed into the air passage 23 of each molten alloy storing tank 10 in the direction of the arrow shown in FIG. 5 to inject the spraying airflow 26 against the rill of the molten alloy poured from each opening 21 to thereby jet a spray flow 15 of atomized alloy (molten alloy) downward from the spraying aperture 22, respectively. Since the inside of the box 18 is filled with an inert gas, each spraying airflow 26 is an inert gas flow.

At this time, each inert gas flow 19 generated by the respective airflow generator 11 is injected approximately horizontally against each downward spray flow 15. This generates an approximately horizontal branched spray flow 16 and 16 of the atomized alloy from the spray flow 15 and 15. This branched spray flow 16 and 16 is jetted against both sides of the aluminum core material 3 which is being transferred downward. The atomized alloy constituting the spray flow 15 sprayed downward has a certain distribution range of particle size. Among the atomized alloy, atomized alloy relatively small in particle size forms an approximately horizontal branched spray flow 16 by the insert gas flow 19, while the atomized alloy relatively large in particle size goes down due to the large mass. Accordingly, the adoption of this spraying method enables the atomized alloy small in particle size among the spray flow 15 to be selectively jetted against and fixed to the aluminum alloy core 3, and therefore a porous layer 4 large in surface area can be formed on both sides of the aluminum core material 3.

The obtained laminate sheet 5 in which the atomized alloy is formed on both sides of the aluminum core material 3 is introduced between the pair of reduction rolls 14 and 14, to thereby obtain the sheet 1 for electrodes according to the present invention. That is, a sheet 1 for electrodes configured such that the porous layer 4 is formed on both sides of the aluminum core material 3 can be obtained.

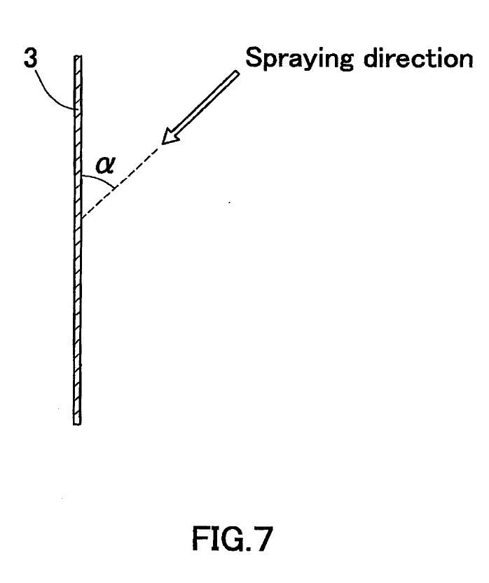

In either embodiments mentioned above, the incident angle α of the atomized alloy jetted against the core material 3 is set to about 90°. However, the incident angle is not specifically limited to it, and can be any angle. The preferable incident angle α (see FIG. 7) is 15° to 90° (including 15° and 90°). If the incident angle is less than 15°, the percentage of atomized alloy which will be flew away without adhering to the core material 3 increases and therefore it is not preferable. The aforementioned “incident angle α” denote an acute angle (including 90°) among the crossing angle with respect to the core material 3 (not obtuse angle, see FIG. 7).

In the explanation of the manufacturing apparatus 9 and that of the manufacturing method, an aluminum core material is used as the core material 3. However, the core material is not limited to it, and can be any core material made of one metal selected from the group consisting of Al, Ti, Zr, Nb, Hf and Ta as a main ingredient.

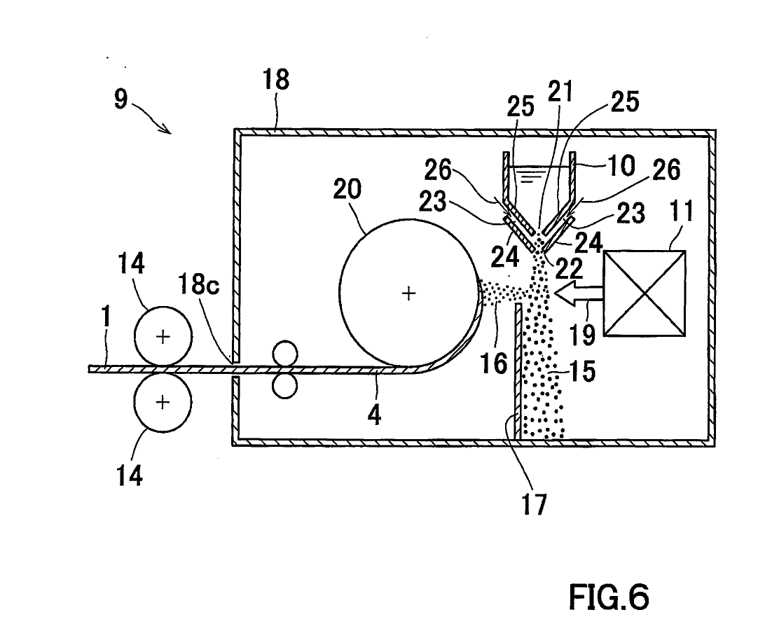

Next, still another method of manufacturing a sheet for capacitor electrodes according to the present invention will be explained with reference to FIG. 6. Initially, molten alloy including one or more valve metals selected from the group consisting of Ti, Zr, Nb, Hf and Ta, and Al is supplied in a molten alloy storing tank 10. The airflow generator 11 is activated and the single-roll 20 is driven, while a spraying airflow 26 is flowed into the air passage 23 of the molten alloy storing tank 10 in the direction of the arrow shown in FIG. 6 to inject the spraying airflow 26 against the rill of the molten alloy poured from the opening 21 to thereby jet a spray flow 15 of atomized alloy (molten alloy) downward from the spraying aperture 22. Since the inside of the box 18 is filled with an inert gas, the spraying airflow 26 is an inert gas flow.

At this time, the inert gas flow 19 generated by the airflow generator 11 is injected approximately horizontally against the downward spray flow 15. This generates an approximately horizontal branched spray flow 16 of the atomized alloy from the spray flow 15. This branched spray flow 16 is jetted against the peripheral surface of the single-roll 20. The atomized alloy constituting the spray flow 15 sprayed downward has a certain distribution range of particle size. Among the atomized alloy, atomized alloy relatively small in particle size forms an approximately horizontal branched spray flow 16 by the insert gas flow 19, while the atomized alloy relatively large in particle size goes down due to the large mass. Accordingly, the adoption of this spraying method enables the atomized alloy small in particle size among the spray flow 15 to be selectively jetted against and fixed to the single-roll 20, and therefore a sheet 4 consisting of a porous layer larger in surface area can be manufactured.

The obtained laminate sheet 4 is extracted outside via the insertion slit 18c and then rolled by being introduced between the pair of reduction rolls 14 and 14, to thereby obtain the sheet 1 for electrodes according to the present invention. That is, a sheet 1 for electrodes constituted by a porous layer 4 can be obtained.

In the aforementioned embodiments, although the adhesion of the atomized alloy to the aluminum core material 3 or the single-roll 20 is performed by the jetting of the atomized alloy, such adhesion is not always limited thereto.

In the manufacturing method of the present invention, it is preferable that the average particle diameter of the atomized alloy to be fixed to the aluminum core material 3 or the single-roll 20 is set to 0.5 to 200 μm. The adhesion of the atomized alloy falling within such particle diameter range enables the formation of porous layer having a larger surface area. Among other things, it is more preferable that the average particle diameter of the atomized alloy to be fixed to the aluminum core material 3 or the single-roll 20 is set to 1 to 100 μm.

Furthermore, it is preferable that the flow rate of the inert gas flow 19 is set to 350 to 1,000 m/sec. If it is less than 350 m/sec., it becomes difficult to generate the branched spray flow 16 and therefore it is not preferable. On the other hand, if it exceeds 1,000 m/sec., the content of percentage of atomized alloy relatively large in particle diameter in the branched spray flow 16 increased therefore it is not preferable. Among other things, it is more preferable to set that the flow rate of the inert gas flow 19 is 400 to 600 m/sec. The most preferable range in relation to the branched spray flow is 400 to 480 m/sec.

As the aforementioned inert gas, nitrogen gas, argon gas and helium gas can be exemplified.

Furthermore, in the manufacturing method of the present invention, it is preferable that the rolling reduction ratio is set to 2 to 60%. If it is less than 2%, sufficient sheet strength cannot be obtained and therefore it is not preferable. On the other hand, if it exceeds 60%, the ductility of the sheet deteriorates remarkably and therefore it is not preferable. Among other things, it is more preferable that the rolling reduction ratio is set to be 5 to 50%, especially 10 to 30%.

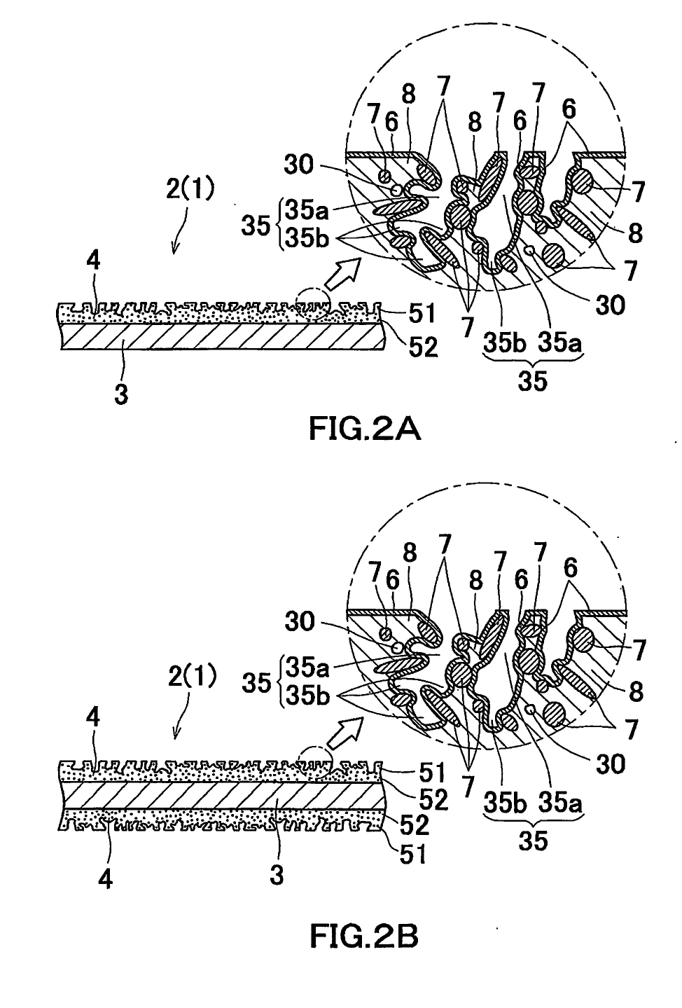

A sheet which is preferably used as an anode material for electrolytic capacitors can be manufactured by electrochemically forming a dielectric film 6 on the surface of the sheet 1 for electrodes according to the present invention and the sheet 1 for electrodes manufactured by the manufacturing method of the present invention by subjecting the sheet to an etching treatment and then to a forming (see FIG. 2). In FIG. 2, the reference numeral “35” denotes an etched pore. Since the porous layer 4 of the sheet 1 for electrodes includes a number of pores 3 (see FIG. 1), an etched pore 35 extended deeply and widely can be formed (see FIG. 2). That is, at the time of the etching treatment, not only an initial invasion pore 35a is simply created, but also the initial invasion pore 35a grows approximately in radial directions toward the pores 30 to thereby create a secondary invasion pore 35b. As a result, an etched pore 35 extended deeply and widely can be formed. Thus, the surface area can be increased remarkably and the contact surface area which comes into contact with electrolytic substance can be increased remarkably. This enables the capacitance as a capacitor to be remarkably increased. In FIG. 2, in the porous layer 4, the reference numeral “51” denotes an etched portion, and “52” denotes a non-etched portion.

As an etching treatment, an etching method in which etching is carried out while passing a direct current in hydrochloric acid liquid can be exemplified, but not limited to it.

Although the forming is not specifically limited, forming in boric liquid, phosphoric acid liquid or adipic acid liquid can be exemplified, but not specifically limited to it.

The electrolytic capacitor according to the present invention is constituted by using the aforementioned anode material 2. Since the electrolytic capacitor uses the anode material 2 made of the sheet 1 for capacitor electrodes, the electrolytic capacitor can be small in size and large in capacity.

### EXAMPLES

Next, examples of the present invention will be explained.

### Example 1

A sheet for capacitor electrodes was manufactured by using the manufacturing apparatus 9 shown in FIG. 3. In detail, molten alloy of Zr—Al series alloy (Al:90 atom %, Zr:0 atom %) was supplied to the molten alloy storing tank 10. A 50 μm thickness aluminum foil core material 3 with the purity of 99.9% or above (Si:30 ppm, Fe: 15 ppm, Cu:40 ppm) was transferred downward through the inert gas atmosphere in the box 18, while a spray flow 15 of the atomized alloy (Zr—Al series molten alloy) was downwardly sprayed via the spraying aperture 22 of the molten alloy storing tank 10. The approximately horizontal inert gas flow 19 from the airflow generator 11 was injected to the spray flow 15 to thereby generate the branched spray flow 16 of the atomized alloy. The branched spray flow 16 was jetted against one side of the aluminum foil core material 3 which was being transferred downward. The incident angle α of the branched spray flow was 90°. Concurrently with this jetting of the branched spray flow, the water cooling type cooling roll 13 was brought into contact with the other side of the aluminum foil core material 3 to conduct the cooling of the core material 3. The flow rate of the inert gas flow 19 was 450 m/sec.

Then, outside the box 18, the laminate sheet 5 with the atomized alloy adhering to the one side of the aluminum alloy core material 3 was introduced between the pair of reduction rolls 14 and 14 at the rolling reduction ratio of 15% to roll it. Thus, a sheet for electrodes was obtained. The rolling was performed while applying ethanol as a lubricant to the surfaces of the rolls 14 and 14.

Subsequently, the obtained sheet for electrodes was immersed in 3%-H₃PO₄ aqueous solution and boiled therein at 90° C. for 120 seconds to degrease. Thereafter, the sheet was washed under running water, and then subjected to ultrasonic cleaning in acetone solvent and dried at 50° for 5 minutes.

Then, an etching treatment was performed. One side etching treatment was performed in the HCl (1 mol/L)+H₂SO₄ (3.5 mol/L) aqueous liquid as etching liquid under the conditions of temperature of 75° C. and current density of 0.5 A/cm² (one side). The etching time was adjusted so that a predetermined etched layer thickness could be obtained.

A constant voltage forming of 20V×10 minutes at the current density of 5 mA/cm² was performed in ammonium phosphate aqueous liquid (concentration 1.5 g/L, 85° C.).

Thereafter, a heat treatment (annealing) was performed at 500° C. for 5 minutes in the air, and then forming was performed again under the same conditions as the aforementioned forming (but, the constant voltage forming was conducted for 5 minutes) to thereby obtain the sheet 1 for electrodes as shown in FIG. 2A.

### Examples 2 to 7

In each example, a sheet for electrodes was obtained in the same manner as in Example 1 except that the molten alloy shown in Table 1 was used.

### Example 8 to 10

In each example, a sheet for electrodes was obtained in the same manner as in Example 1 except that the incident angle α of the atomized alloy with respect to the core material at the time of jetting the atomized alloy against the core material was set to the angle shown in Table 1.

### Example 11 to 13

In each example, a sheet for electrodes was obtained in the same manner as in Example 1 except that the average particle diameter of the atomized alloy adhering to the core material was set to the size shown in Table 2 by setting the flow rate of the inert gas flow 19 from the airflow generator 11 to the flow rate shown in Table 2.

### Examples 14 to 16

In each example, a sheet for electrodes was obtained in the same manner as in Example 1 except that the rolling reduction ratio by the reduction rolls was set to the value shown in Table 2.

### Example 17

A sheet for capacitor electrodes was manufactured by using the manufacturing apparatus 9 shown in FIG. 5. In detail, molten alloy of Zr—Al series alloy (Al: 90 atom %, Zr: 10 atom %) was supplied to each of the two molten alloy storing tanks 10 and 10. A 50 μm thickness aluminum foil core material 3 with the purity of 99.9% or above (Si:30 ppm, Fe: 15 ppm, Cu: 40 ppm) was transferred downward through the inert gas atmosphere in the box 18, while a spray flow 15 of the atomized alloy (Zr—Al series molten alloy) was downwardly sprayed via the spraying aperture 22 of each of the molten alloy storing tanks 10 and 10. The approximately horizontal inert gas flow 19 from each of the airflow generators 11 and 11 was injected to the spray flow 15 to thereby generate the branched spray flow 16 of each atomized alloy. Both the branched spray flows 16 were jetted against both sides of the aluminum foil core material 3 which was being transferred downward. The incident angle α of each branched spray flow was 90°. The flow rate of each inert gas flow 19 was 450 m/sec.

Then, outside the box 18, the laminate sheet 5 with the atomized alloy adhering to both sides of the aluminum alloy core material 3 was introduced between the pair of reduction rolls 14 and 14 at the rolling reduction ratio of 20% to be rolled. Thus, a sheet for electrodes was obtained. The rolling was performed while applying ethanol as a lubricant to the surfaces of the rolls 14 and 14.

Subsequently, the obtained sheet for electrodes was immersed in 3%-H₃PO₄ aqueous solution and boiled therein at 90° C. for 120 seconds to degrease. Thereafter, the sheet was washed under running water, and then subjected to ultrasonic cleaning in acetone solvent and dried at 50° C. for 5 minutes.

Then, an etching treatment was performed. Both sides etching treatment was performed in the HCl (1 mol/L)+H₂SO₄ (3.5 mol/L) aqueous liquid as etching liquid under the conditions of temperature of 75° C. and current density of 0.5 A/cm² (one side). The etching time was adjusted so that a predetermined etched layer thickness could be obtained.

A constant voltage forming of 20V×10 minutes at the current density of 5 mA/cm² was performed in ammonium phosphate aqueous liquid (concentration 1.5 g/L, 85° C.).

Thereafter, a heat treatment (annealing) was performed at 500° C. for 5 minutes in the air, and then forming was performed again under the same conditions as the aforementioned forming (but, the constant voltage forming was 5 minutes) to obtain the sheet 1 for electrodes as shown in FIG. 2B.

### Example 18

In each example, a sheet 1 for electrodes was obtained in the same manner as in Example 17 except that the airflow generators 11 were removed and the spray flows 15 of the atomized alloy (Zr—Al series molten alloy) sprayed from the spray aperture 11 of each molten alloy storing tanks 10 and 10 were directly applied (not as branched spray flows) to both sides of the aluminum foil core materials 3. The incident angle α of each branched spray flow was 90

### Example 19

A sheet for capacitor electrodes was manufactured by using the manufacturing apparatus 9 shown in FIG. 6. In detail, molten alloy of Zr—Al series alloy (Al:85 atom %, Zr:15 atom %) was supplied to the molten alloy storing tank 10. The airflow generator 11 was activated and the single roll 20 was driven, while a spray flow 15 of the atomized alloy (Zr—Al series molten alloy) was downwardly sprayed via the spraying aperture 22 of the molten alloy storing tank 10. The approximately horizontal inert gas flow 19 from the airflow generator 11 was injected to the spray flow 15 to thereby generate the branched spray flow 16 of the atomized alloy. The branched spray flow 16 was jetted against the peripheral surface of the single roll 20. The incident angle α of the branched spray flow was 90°. The flow rate of the inert gas flow 19 was 450 m/sec.

Then, outside the box 18, the obtained laminate sheet 5 was introduced between the pair of reduction rolls 14 and 14 at the rolling reduction ratio of 15% to roll it. Thus, a sheet for electrodes was obtained. The rolling was performed while applying ethanol as a lubricant to the surfaces of the rolls 14 and 14.

Subsequently, by performing the same degreasing treatment, etching treatment, first forming, annealing treatment and second forming as in Example 1, a sheet for electrodes was obtained.

### Examples 20 to 29

A sheet 1 for electrodes was obtained in the same manner as in Example 1 except that as the core material the material shown in Table 3 was used.

### Comparative Example 1

An ingot of Zr—Al series alloy (Al:85 atom %, Zr:15 atom %) was dissolved at 1,650° C. was cast in a cupper casting mold to obtain 1 mm thickness alloy plate. Then, this alloy plate was crushed and then made the Al solid solution dissolve in 15% hydrochloric acid aqueous solution (bath temperature of 50° C.). A pressure of 10 Mpa was applied to the obtained Zr—Al intermetallic compound into a pressed powder material. Then, the pressed powder material was heated and sintered in vacuum at 1,300° C. for 1 hour. Thus, a 150 μm thickness sheet for electrodes was obtained.

### Comparative Example 2

In a vacuum deposition apparatus, a 30 μm thickness aluminum foil core material with the purity of 99.9% or above (Si:30 ppm, Fe:15 ppm; Cu:40 ppm) was mounted and a Zr—Al series alloy (Al:90 atom %, Zr:10 atom %) ingot was set to the heating portion. Then, under the vacuum condition, deposition was performed by evaporating the ingot to form a 0.5 μm thickness Zr—Al series alloy film on one side of the aluminum core material. Thus, a sheet for electrodes was obtained.

The porosity of the porous layer 4 of each obtained sheet for electrodes is shown in Tables 4 to 6. The measuring method of the porosity is as follows.

<Measuring Method of Porocity>

After fixing one surface of the sheet for electrodes to a fixing table via an adhesive agent, the cross-section of the sheet was emerized and buffed into a smooth surface. Thereafter, a carbon deposited film of about 20 to 50 nm thickness was attached to the cross-section, and the composition image of the cross-section was observed by a scanning electron microscope (SEM) to measure the area of the void portion by setting the threshold of binary processing between the (internal compound+solid solution) and the void. The ratio (%) of the area of the void portion occupied in the total area of the observed cross-section was regarded as a void ratio.

The bent-resistant performance of each of the obtained sheets for electrodes was evaluated based on the below-mentioned bent-resistant performance evaluation method.

<Bent-Resistant Performance Evaluation Method>

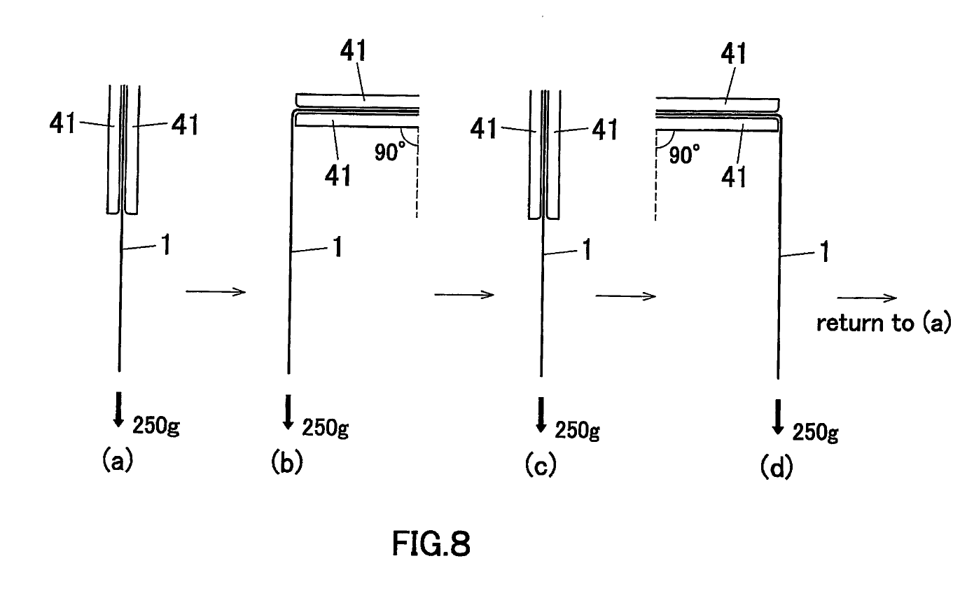

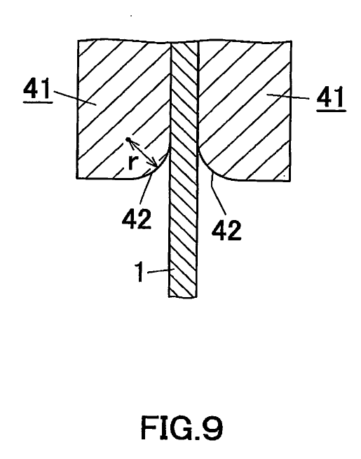

The evaluation of the bent-resistant performance was performed by using a M.I.T. type tester (JIS P8115). In detail, one end portion of a strip of the sheet for electrodes having a width of 10 mm was pinched by and between steel pinching jigs 41 and 41 each having an arc-shaped tip end portion 42 of 1 mm curvature radius (see FIG. 9). Then, a spring load of 250 g was applied to the other end of the sheet for electrodes, so that the sheet was hung down vertically as shown in (a) of FIG. 8. While applying the spring load, as shown in (b) of FIG. 8, the jigs 41 and 41 were rotated clockwise by 90 degree, and then returned to the vertical position as shown in (c) of FIG. 8, and thereafter rotated counterclockwise by 90 degree as shown in (d) of FIG. 8, and then returned to the vertical position as shown in (a) of FIG. 8. These series of steps constitute one cycle. If the sheet for electrodes is not broken down at this stage, a second cycle will be performed in the order of (a), (b), (c), (d) and (a). The same steps will be repeated until the sheet for electrodes is broken down and counted the cycle number until the breakdown. Based on this, the bent-resistant performance of the sheet for electrodes was evaluated. For example, in the case where the sheet was broken down during the 8^{th} cycle, the evaluation will be “7 cycles.” The repeating speed of the cycle was 90 cycles per minute.

Furthermore, an electrolytic capacitor mentioned below was manufactured by using each of the obtained sheet for electrodes.

<Manufacturing Method of Capacitor (Structure of a Capacitor)>

A small piece of 5×3.5 mm was cut out from the etched and formed sheet 1 for electrodes. A divisional portion of the sheet was formed by covering a part of both surfaces of the sheet located at the inside of 1 to 2 mm from the longitudinal end portion with polymethylmethacrylate resin of 1 mm width×3.5 mm length. The larger partitioned portion (3 mm×3.5 mm) between the two partitioned portions divided by the divisional portion was chemically converted again in ammonium phosphate aqueous liquid, and thereafter polypyrrole (persulfate ammonium as oxidizing agent, unsorakinon sodium sulfonic acid as dopant, under the existence of dopant, the reaction between pyrrole and oxidizing reagent was repeated) was filled in the etched pores as a cathode and formed thereon. Furthermore, after laminating carbon paste and silver pate in this order, a lead frame was connected to a certain portion, and sealing was performed with epoxy resin. Thus, a chip shaped electrolytic capacitor of operating voltage of 10 V was manufactured.

The evaluation of each electrolytic capacitor obtained as mentioned above was made.

<Evaluation>

The capacitance (μF), equivalent series resistance (Ω) and LC value (leakage current)(μA) of each capacitor was measured. The results are shown in Tables 4 to 6. Each measured value is the average of measured values of five capacitors.

TABLE 1

| | Manufacturing conditions | | | | | | | | | |
|---|---|---|---|---|---|---|---|---|---|---|
| | | | | | | | | Average particle | | |
| | | | | | | | | diameter of | | |
| | | | | | | | Flow rate of | adhering | Incident | Rolling |
| | Composition of molten alloy (atom %) | | | | | | inert gas flow | atomized alloy | angle α | reduction |
| | Al | Ti | Zr | Nb | Hf | Ta | (m/sec) | (μm) | (°) | ratio (%) |
| Example No. 1 | 90 | — | 10 | — | — | — | 450 | 50 | 90 | 15 |
| Example No. 2 | 85 | — | 15 | — | — | — | 450 | 50 | 90 | 15 |
| Example No. 3 | 95 | — | — | 5 | — | — | 450 | 50 | 90 | 15 |
| Example No. 4 | 88 | — | — | 12 | — | — | 450 | 50 | 90 | 15 |
| Example No. 5 | 90 | 10 | — | — | — | — | 450 | 50 | 90 | 15 |
| Example No. 6 | 90 | — | — | — | 10 | — | 450 | 50 | 90 | 15 |
| Example No. 7 | 90 | — | — | — | — | 10 | 450 | 50 | 90 | 15 |
| Example No. 8 | 90 | — | 10 | — | — | — | 450 | 50 | 60 | 15 |
| Example No. 9 | 90 | — | 10 | — | — | — | 450 | 30 | 30 | 15 |
| Example No. 10 | 90 | — | 10 | — | — | — | 450 | 20 | 10 | 15 |

“—” denotes that the atom % is less than 0.1

TABLE 2

| | Manufacturing conditions | | | | | | | | | |
|---|---|---|---|---|---|---|---|---|---|---|
| | | | | | | | | Average particle | | |
| | | | | | | | | diameter of | | |
| | | | | | | | Flow rate of | adhering | Incident | Rolling |
| | Composition of molten alloy (atom %) | | | | | | inert gas flow | atomized alloy | angle α | reduction |
| | Al | Ti | Zr | Nb | Hf | Ta | (m/sec) | (μm) | (°) | ratio (%) |
| Example No. 11 | 90 | — | 10 | — | — | — | 850 | 5 | 90 | 15 |
| Example No. 12 | 90 | — | 10 | — | — | — | 650 | 30 | 90 | 15 |
| Example No. 13 | 90 | — | 10 | — | — | — | 350 | 150 | 90 | 15 |
| Example No. 14 | 90 | — | 10 | — | — | — | 450 | 50 | 90 | 20 |
| Example No. 15 | 90 | — | 10 | — | — | — | 450 | 50 | 90 | 30 |
| Example No. 16 | 90 | — | 10 | — | — | — | 450 | 50 | 90 | 45 |
| Example No. 17 | 90 | — | 10 | — | — | — | 450 | 50 | 90 | 15 |
| Example No. 18 | 90 | — | 10 | — | — | — | 650 | 120 | 90 | 15 |
| Example No. 19 | 85 | — | 15 | — | — | — | 450 | 50 | 90 | 15 |

“—” denotes that the atom % is less than 0.1

TABLE 3

| | Manufacturing conditions | | | | |
|---|---|---|---|---|---|
| | | | Average particle | | |
| | | | diameter of | | |
| | | Flow rate of | adhering | Incident | Rolling |
| | | inert gas flow | atomized alloy | angle α | reduction |
| | Structure of core material | (m/sec) | (μm) | (°) | ratio (%) |
| Example No. 20 | High purity Ti foil | 450 | 50 | 90 | 15 |
| Example No. 21 | High purity Zr foil | 450 | 50 | 90 | 15 |
| Example No. 22 | High prity Nb foil | 450 | 50 | 90 | 15 |
| Example No. 23 | High purity Hf foil | 450 | 50 | 90 | 15 |
| Example No. 24 | High purity Ta foil | 450 | 50 | 90 | 15 |
| Example No. 25 | Ti—Al series alloy | 450 | 50 | 90 | 15 |
| | (Ti: 0.5 atom %, Al: 99.5 atom %) | | | | |
| Example No. 26 | Zr—Al series alloy | 450 | 50 | 90 | 15 |
| | (Zr: 0.5 atom %, Al: 99.5 atom %) | | | | |
| Example No. 27 | Nb—Al series alloy | 450 | 50 | 90 | 15 |
| | (Nb: 0.5 atom %, Al: 99.5 atom %) | | | | |
| Example No. 28 | Hf—Al series alloy | 450 | 50 | 90 | 15 |
| | (Hf: 0.5 atom %, Al: 99.5 atom %) | | | | |
| Example No. 29 | Ta—Al series alloy | 450 | 50 | 90 | 15 |
| | (Ta: 0.5 atom %, Al: 99.5 atom %) | | | | |

TABLE 4

| | Obtained anode material | | | | | | | | |
|---|---|---|---|---|---|---|---|---|---|
| | | | Porous layer | | | | | | |
| | | | Non-etched | | | Evaluation | | | |
| | | | portion | Etched portion | | | equivalent | LC | |
| | Total | Core | Thickness | Thickness | | | series | Leakage | Bent-resistant |
| | thickness | thickness | (one side) | (one side) | Porocity | Capacitance | resistance | current | performance |
| | (μm) | (μm) | (μm) | (μm) | (%) | (μF) | (Ω) | (μA) | (cycle) |
| Example 1 | 180 | 50 | 10 | 120 | 60 | 25 | 0.8 | 0.4 | 12 |
| Example 2 | 180 | 50 | 10 | 120 | 40 | 18 | 0.7 | 0.3 | 10 |
| Example 3 | 180 | 50 | 10 | 120 | 65 | 27 | 0.8 | 0.4 | 13 |
| Example 4 | 180 | 50 | 10 | 120 | 45 | 21 | 0.6 | 0.4 | 11 |
| Example 5 | 180 | 50 | 10 | 120 | 65 | 30 | 0.7 | 0.8 | 13 |
| Example 6 | 180 | 50 | 10 | 120 | 55 | 30 | 0.6 | 0.6 | 13 |
| Example 7 | 180 | 50 | 10 | 120 | 55 | 32 | 0.6 | 0.7 | 12 |
| Example 8 | 135 | 30 | 10 | 95 | 55 | 25 | 0.6 | 0.3 | 13 |
| Example 9 | 115 | 30 | 10 | 75 | 50 | 22 | 0.6 | 0.2 | 14 |
| Example 10 | 100 | 30 | 10 | 60 | 45 | 18 | 0.6 | 0.2 | 15 |

TABLE 5

| | Obtained anode material | | | | | | | | |
|---|---|---|---|---|---|---|---|---|---|
| | | | Porous layer | | | | | | |
| | | | Non-etched | | | Evaluation | | | |
| | | | portion | Etched portion | | | equivalent | LC | |
| | Total | Core | Thickness | Thickness | | | series | Leakage | Bent-resistant |
| | thickness | thickness | (one side) | (one side) | Porosity | Capacitance | resistance | current | performance |
| | (μm) | (μm) | (μm) | (μm) | (%) | (μF) | (Ω) | (μA) | (cycle) |
| Example 11 | 130 | 50 | 10 | 70 | 70 | 18 | 0.6 | 0.4 | 15 |
| Example 12 | 150 | 50 | 10 | 90 | 65 | 24 | 0.5 | 0.3 | 8 |
| Example 13 | 250 | 50 | 10 | 190 | 60 | 15 | 0.9 | 0.4 | 14 |
| Example 14 | 190 | 55 | 10 | 125 | 65 | 28 | 1.8 | 0.4 | 12 |
| Example 15 | 165 | 45 | 10 | 110 | 60 | 23 | 0.3 | 0.4 | 11 |
| Example 16 | 145 | 40 | 10 | 95 | 55 | 20 | 0.3 | 0.4 | 6 |
| Example 17 | 220 | 50 | 5*⁴ | 80*¹ | 60 | 31 | 0.4 | 0.3 | 6 |
| Example 18 | 140 | 30 | 5*⁴ | 50*² | 55 | 24 | 0.7 | 0.4 | 4 |
| Example 19 | 80 | | 10 | 60 | 30 | 13 | 0.9 | 0.4 | 4 |
| Com. Ex. 1 | 150 | | 30 | 60*³ | 20 | 8 | 1.8 | 0.3 | 0 |
| Com. Ex. 2 | 10.5 | 10 | 0.5 | | — | 4 | 2.0 | 0.2 | 20 |

*¹Total thickness of both surfaces is 160 μm
*²Total thickness of both surfaces is 100 μm
*³Total thickness of both surfaces is 120 μm
*⁴Total thickness of both surfaces is 10 μm

TABLE 6

| | Obtained anode material | | | | | | | | |
|---|---|---|---|---|---|---|---|---|---|
| | | | Porous layer | | | | | | |
| | | | Non-etched | | | Evaluation | | | |
| | | | portion | Etched portion | | | equivalent | LC | |
| | Total | Core | Thickness | Thickness | | | series | Leakage | Bent-resistant |
| | thickness | thickness | (one side) | (one side) | Porosity | Capacitance | resistance | current | performance |
| | (μm) | (μm) | (μm) | (μm) | (%) | (μF) | (Ω) | (μA) | (cycle) |
| Example 20 | 180 | 50 | 10 | 120 | 60 | 25 | 0.9 | 0.9 | 25 |
| Example 21 | 180 | 50 | 10 | 120 | 60 | 25 | 0.7 | 0.6 | 28 |
| Example 22 | 180 | 50 | 10 | 120 | 60 | 25 | 0.8 | 0.7 | 30 |
| Example 23 | 180 | 50 | 10 | 120 | 65 | 25 | 0.7 | 0.4 | 28 |
| Example 24 | 180 | 50 | 10 | 120 | 60 | 25 | 0.7 | 0.6 | 28 |
| Example 25 | 180 | 50 | 10 | 120 | 60 | 25 | 0.8 | 0.8 | 11 |
| Example 26 | 180 | 50 | 10 | 120 | 60 | 25 | 0.8 | 0.8 | 13 |
| Example 27 | 180 | 50 | 10 | 120 | 60 | 25 | 0.7 | 0.7 | 13 |
| Example 28 | 180 | 50 | 10 | 120 | 60 | 25 | 0.7 | 0.5 | 14 |
| Example 29 | 180 | 50 | 10 | 120 | 60 | 25 | 0.6 | 0.6 | 14 |

<Evaluation Results>

As will be apparent from Tables, the sheets for electrodes according to Examples 1 to 29 of the present invention has no crack after the bending steps and therefore is excellent in bent-resistant performance. Furthermore, in the electrolytic capacitors constituted by using the sheet for electrodes according to Examples 1 to 29 of the present invention, it is confirmed that the leakage current can be extremely decreased and the capacitor can be small in size but large in capacitance.

To the contrary, the sheet for electrodes according to Comparative Example 1 was poor in bent-resistant performance. The capacitance of the electrolytic capacitor constituted by the sheet for electrodes according to Comparative Example 2 was smaller than that of Example 1 to 29.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

### INDUSTRIAL APPLICABILITY

The sheet for capacitor electrodes, the sheet for capacitor electrodes manufactured by the manufacturing method according to the present invention, and the sheet for capacitor electrodes manufactured by the manufacturing apparatus according to the present invention can be preferably used as, for example, an anode material for electrolytic capacitors. By utilizing the sheet for capacitance electrodes, an electrolytic capacitor (e.g., aluminum solid electrolytic capacitor) small in size and large in capacitance can be provided.

1. A sheet for capacitor electrodes, comprising:
a porous layer including an intermetallic compound made of one or more valve metals selected from the group consisting of Ti, Zr, Nb, Hf and Ta, and Al,
wherein the porous layer is constituted such that particles of the intermetallic compound are fixed in solid solution in which the one or more valve metals are dissolved in Al, and
wherein porosity of the porous layer is 10% or above.

2. A sheet for capacitor electrodes, comprising:
a sheet in which a porous layer including an intermetallic compound made of one or more valve metals selected from the group consisting of Ti, Zr, Nb, Hf and Ta, and Al is integrally laminated on at least one surface of a core material including one metal selected from the group consisting of Al, Ti, Zr, Nb, Hf and Ta as a main ingredient,
wherein the porous layer is constituted such that particles of the intermetallic compound are fixed in solid solution in which the one or more valve metals are dissolved in Al, and
wherein porosity of the porous layer is 10% or above.

3. The sheet for capacitor electrodes as recited in claim 2, wherein a thickness of the core material is 5 to 80 μm and a thickness of the porous layer is 5 to 300 μm.

4. The sheet for capacitor electrodes as recited in claim 1, wherein the porosity of the porous layer is 10 to 75%.

5. A method of manufacturing a sheet for capacitor electrodes, the method comprising the steps of:
atomizing molten alloy including one or more valve metals selected from the group consisting of Ti, Zr, Nb, Hf and Ta, and Al into atomized molten alloy;
continuously applying the atomized alloy on a peripheral surface of a rotating single-roll; and
quickly solidifying the applied alloy to obtain a porous sheet.

6. The method of manufacturing a sheet for capacitor electrodes as recited in claim 5, wherein an average particle diameter of the atomized alloy to be fixed to the single-roll is 0.5 to 200 μm.

7. A method of manufacturing a sheet for capacitor electrodes, the method comprising the steps of:
atomizing molten alloy including one or more valve metals selected from the group consisting of Ti, Zr, Nb, Hf and Ta, and Al into atomized molten alloy; and
applying the atomized molten alloy on at least one surface of a foil-like core material containing at least one metal selected from the group consisting of Al, Ti, Zr, Nb, Hf and Ta as a main ingredient.

8. A method of manufacturing a sheet for capacitor electrodes, the method comprising the steps of:
atomizing molten alloy including one or more valve metals selected from the group consisting of Ti, Zr, Nb, Hf and Ta, and Al into atomized molten alloy;
applying the atomized molten alloy on at least one surface of a foil-like core material containing at least one metal selected from the group consisting of Al, Ti, Zr, Nb, Hf and Ta as a main ingredient to obtain a laminate sheet; and
rolling the laminate sheet.

9. The method of manufacturing a sheet for capacitor electrodes as recited in claim 8, wherein the laminate sheet is rolled at a rolling reduction ratio of 2 to 60%.

10. The method of manufacturing a sheet for capacitor electrodes as recited in claim 7, wherein in the step of obtaining the laminate sheet the atomized alloy is jetted to at least one surface of the core material in an inert gas atmosphere to fix the atomized alloy thereto.

11. The method of manufacturing a sheet for capacitor electrodes as recited in claim 7, wherein in the step of obtaining the laminate sheet the atomized alloy is fixed on both surfaces of the core material simultaneously.

12. A method of manufacturing a sheet for capacitor electrodes, the method comprising the steps of:
atomizing molten alloy including one or more valve metals selected from the group consisting of Ti, Zr, Nb, Hf and Ta, and Al into atomized molten alloy; and
applying the atomized molten alloy on one surface of a foil-like core material containing at least one metal selected from the group consisting of Al, Ti, Zr, Nb, Hf and Ta as a main ingredient, and cooling the core material with the alloy by bringing a cooling roll into contact with the other surface of the core material concurrently with or after the application step of the atomized molten alloy to obtain a laminate sheet.

13. A method of manufacturing a sheet for capacitor electrodes, the method comprising the steps of:
atomizing molten alloy including one or more valve metals selected from the group consisting of Ti, Zr, Nb, Hf and Ta, and Al into atomized molten alloy;
applying the atomized molten alloy on one surface of a foil-like core material containing at least one metal selected from the group consisting of Al, Ti, Zr, Nb, Hf and Ta as a main ingredient, and cooling the core material with the alloy by bringing a cooling roll into contact with the other surface of the core material concurrently with or after the application step of the atomized molten alloy to obtain a laminate sheet; and
rolling the laminate sheet.

14. The method of manufacturing a sheet for capacitor electrodes as recited in claim 13, wherein the laminate sheet is rolled at a rolling reduction ratio of 2 to 60%.

15. The method of manufacturing a sheet for capacitor electrodes as recited in claim 12, wherein in the step of obtaining the laminate sheet the atomized alloy is jetted on at least one surface of the core material in an inert gas atmosphere to fix thereon.

16. A method of manufacturing a sheet for capacitor electrodes, the method, comprising:
spraying atomized molten alloy including one or more valve metals selected from the group consisting of Ti, Zr, Nb, Hf and Ta, and Al approximately downward;
injecting an inert gas flow against the spray flow to generate a branched spray flow of the atomized alloy from the spray flow;
jetting the branched spray flow against a foil-like core material including one metal selected from the group consisting of Al, Ti, Zr, Nb, Hf and Ta as a main ingredient to fix the atomized alloy on at least one surface of the core material to obtain a laminate sheet.

17. The method of manufacturing a sheet for capacitor electrodes as recited in claim 16, wherein the laminate sheet is rolled at a rolling reduction ratio of 2 to 60%.

18. A method of manufacturing a sheet for capacitor electrodes, the method, comprising:
spraying atomized molten alloy including one or more valve metals selected from the group consisting of Ti, Zr, Nb, Hf and Ta, and Al approximately downward;
injecting an inert gas flow against the spray flow in an approximately horizontal direction to generate a branched spray flow of the atomized alloy from the spray flow in an approximately horizontal direction;
jetting the branched spray flow against a foil-like core material including one metal selected from the group consisting of Al, Ti, Zr, Nb, Hf and Ta as a main ingredient to fix the atomized alloy which is being transferred in an approximately up-and-down direction on at least one surface of the core material to obtain a laminate sheet; and
rolling the laminate sheet.

19. The method of manufacturing a sheet for capacitor electrodes as recited in claim 16, further comprising the step of:
cooling the core material with the alloy by bringing a cooling roll into contact with one surface of the core material concurrently with or after the application step of the atomized molten alloy on the other surface of the core material to obtain a laminate sheet.

20. The method of manufacturing a sheet for capacitor electrodes as recited in claim 16, wherein a flow rate of the inert gas atmosphere is set to 350 to 1,000 m/sec.

21. The method of manufacturing a sheet for capacitor electrodes as recited in claim 10, wherein the atomized alloy is jetted against the core material at an incident angle of 150 to 90°.

22. The method of manufacturing a sheet for capacitor electrodes as recited in claim 5, wherein the molten alloy is a molten alloy consisting essentially of Zr: 5 to 20 atomic %, aluminum and inevitable impurities.

23. The method of manufacturing a sheet for capacitor electrodes as recited in claim 5, wherein the molten alloy is a molten alloy consisting essentially of Nb: 3 to 20 atomic %, aluminum and inevitable impurities.

24. The method of manufacturing a sheet for capacitor electrodes as recited in claim 5, wherein atomizing the molten alloy is performed by injecting an injection airflow against a flow of molten alloy particles.

25. The method of manufacturing a sheet for capacitor electrodes as recited in claim 7, wherein an average particle diameter of the atomized alloy to be fixed to the core material is 0.5 to 200 μm.

26. The method of manufacturing a sheet for capacitor
electrodes as recited in claim 7, wherein an aluminum foil or an alloy foil including one or more valve metals selected from the group consisting of Ti, Zr, Nb, Hf and Ta, and Al is used as the core material.

27. A method of manufacturing an anode material for electrolytic capacitors, the method, comprising:
etching the sheet for electrodes obtained by the method as recited in claim 5; and thereafter performing a forming of the etched sheet to form a dielectric film on the surface thereof.

28. An anode material for electrolytic capacitors manufactured by the method as recited in claim 27.

29. A method of manufacturing an anode material for electrolytic capacitors, the method, comprising the steps of: etching the sheet for electrodes as recited in claim 1; and thereafter
performing a forming of the etched sheet to form a dielectric film on the surface thereof.

30. An anode material for electrolytic capacitors manufactured by the method as recited in claim 29.

31. An electrolytic capacitor constituted by the anode material as recited in claim 28.

32. An apparatus for manufacturing a sheet for capacitor electrodes, comprising:
an airflow generator which generates an airflow;
a supporter disposed at a leeward side of the airflow generated by the airflow generator; and
a molten alloy storing tank having a spraying aperture, the molten alloy storing tank being disposed above an intermediate position between the supporter and the molten alloy storing tank.

33. The apparatus for manufacturing a sheet for capacitor electrodes as recited in claim 32, wherein the airflow generator is an apparatus for generating an airflow in an approximately horizontal direction.

34. The apparatus for manufacturing a sheet for capacitor electrodes as recited in claim 32, further comprising a pair of reduction rolls.

35. The apparatus for manufacturing a sheet for capacitor electrodes as recited in claim 32, further comprising a shielding plate disposed at a position below the spraying aperture of the molten alloy storing tank.

36. The apparatus for manufacturing a sheet for capacitor electrodes as recited in claim 32, wherein cooling rolls are used as the supporter.
